(19) United States
(12) Patent Application Publication
(10) Pub. No.: US 2017/0186261 A1
(43) Pub. Date: Jun. 29, 2017

(54) COIN TELLER MACHINE AND SELF-CHECKOUT APPARATUS

(71) Applicant: TOSHIBA TEC KABUSHIKI KAISHA, Tokyo (JP)

(72) Inventor: Ryuta HARAGUCHI, Tagata Shizuoka (JP)

(21) Appl. No.: 15/369,869

(22) Filed: Dec. 5, 2016

(30) Foreign Application Priority Data
Dec. 28, 2015 (JP) 2015-257315

(51) Int. Cl. G07D 1/00

(52) U.S. Cl. CPC G07D 1/00

(57) ABSTRACT

According to an embodiment, a coin teller machine includes a guide member, a detection device and a processor. The guide member transfers to one of a first state of guiding the coins discharged by the storage device to the coin acceptor, and a second state of guiding the coins discharged by the storage device to the recovery container. The detection device detects the state of the guide member. The processor outputs a guidance destination of the coin provided by the guide member determined based on the detection result of the detection device to a predetermined output destination.

### CROSS-REFERENCE TO RELATED APPLICATION

This application is based upon and claims the benefit of priority from the prior Japanese Patent Application No. 2015-257315, filed on Dec. 28, 2015, the entire contents of which are incorporated herein by reference.

### FIELD

The embodiments to be described herein generally relates to a coin teller machine and a self-checkout apparatus.

### BACKGROUND

Conventionally, a coin teller machine has been used as a part of a sales system in stores. The coin teller machine circulates coins taken in from outside a casing, and pays coins out of the casing as changes. The coin teller machine is used with a POS terminal. Further, the coin teller machine is incorporated in a self-checkout apparatus. As a teller machine used with the POS terminal or as a teller machine incorporated in the self-checkout apparatus, there is a bill teller machine in addition to the aforementioned coin teller machine.

Since the coin teller machine cannot be operated when a storage unit configured to store coins is filled, the coin teller machine moves the coins in the storage unit to a recovery container in consideration of an amount of storage of coins in the storage unit (coin recovery). The coin teller machine has a discharge route for paying the coin out of the storage unit to a change tray as changes (change payout), and a discharge route for guiding and recovering the coin from the storage unit to the recovery container. The alteration of the discharge route is achieved by switching the direction of the guide member for guiding the coins that makes up of a part of the discharge route.

As described above, the conventional coin teller machine alters the discharge route of the coin, by switching the direction of the guide member, and switches the change payout and the coin recovery. However, the conventional coin teller machine has no means for checking whether the direction of the guide member is switched.

### BRIEF DESCRIPTION OF THE DRAWINGS

FIG. 1 is a perspective view illustrating an external shape of a coin teller machine according to an embodiment;

FIG. 2 is a cross-sectional plan view illustrating a schematic structure of a coin teller machine according to the embodiment;

FIG. 3 is a vertical right side view illustrating a structure around the change tray when the guide member of the discharge route of the coin teller machine according to the embodiment is in a change payout state;

FIG. 4 is a right rear perspective view illustrating a structure around the change tray of FIG. 3;

FIG. 5 is a perspective view illustrating an external shape of the guide member provided in the discharge route of the coins in the coin teller machine according to the embodiment;

FIG. 6 is a vertical right side view illustrating a structure around the change tray when the guide member of the discharge route of the coin teller machine according to the embodiment is in a coin recovery state;

FIG. 7 is a right rear perspective view illustrating the structure around the change tray of FIG. 6;

FIG. 8A is a block diagram illustrating a hardware configuration of the coin teller machine according to the embodiment;

FIG. 8B is a block diagram illustrating a functional structure of the coin teller machine according to the embodiment;

FIG. 9 is a flowchart illustrating a control process for coin recovery in the coin teller machine according to the embodiment; and

FIG. 10 is a perspective view illustrating an external shape of a self-checkout apparatus according to the embodiment.

### DETAILED DESCRIPTION

According to an embodiment, the coin teller machine includes a storage device, a coin acceptor, a recovery container, a guide member, a detection device and a processor. The storage device is provided in the casing, stores coins taken in from outside the casing and discharges the stored coins at a predetermined timing. The coin acceptor receives the coins discharged by the storage device by exposing the coins to the outside of the casing. The recovery container recovers the coins discharged by the storage device. The guide member transfers to one of a first state of guiding the coins discharged by the storage device to the coin acceptor, and a second state of guiding the coins discharged by the storage device to the recovery container. The detection device detects the state of the guide member. The processor outputs a guidance destination of the coin provided by the guide member determined based on the detection result of the detection device to a predetermined output destination.

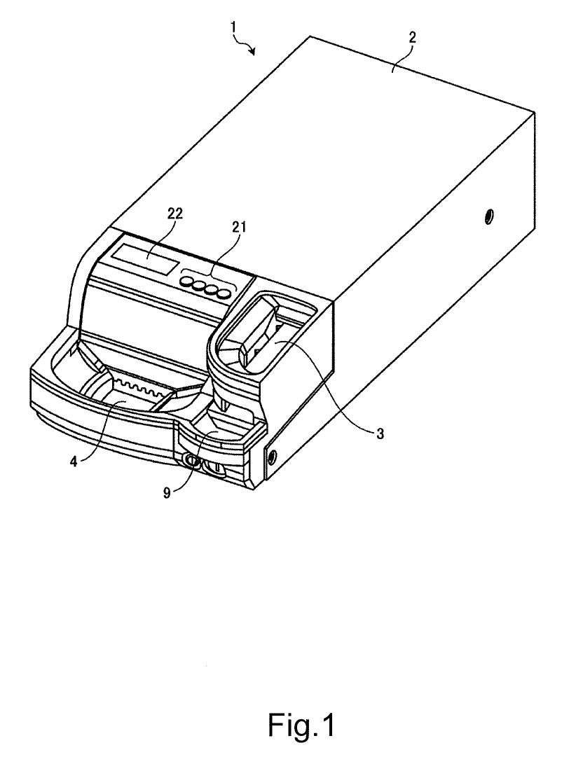

Hereinafter, embodiments will be described with reference to the drawings. In the drawings, same reference numerals designate same or similar parts. FIG. 1 is a perspective view illustrating an external shape of a coin teller machine 1 of the present embodiment. The coin teller machine 1 is an apparatus that circulates coins taken in from outside a casing 2 and pays the coins out of the casing 2 as changes, and is also referred to as a change machine. Such a coin teller machine 1 is used, for example, with a POS terminal (not illustrated).

The coin teller machine 1 has a slot 3 that introduces coins into the casing 2.

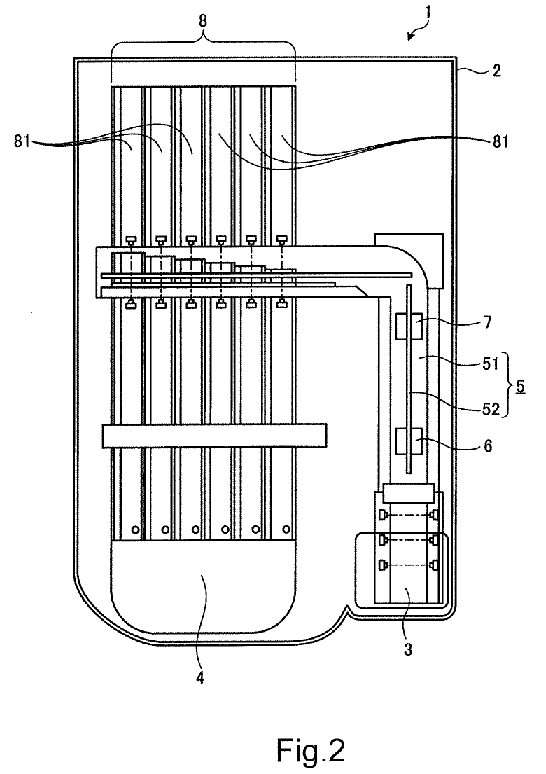

The coin teller machine 1 has a coin acceptor 4 that receives coins discharged by a storage device 8 (see FIG. 2) to be described later, while exposing the coins to the outside of the casing 2. Specifically, for example, the coin acceptor 4 is a change tray provided on the front surface of the casing 2. Hereinafter, the coin acceptor 4 will be referred to as a change tray 4. The change tray 4 receives the changes (coins) paid out of the casing 2, and holds the changes to be drawable from the outside of the casing 2. The change tray 4 is a dish-like member having an opening on the upper surface, and easily draws the changes from the outside of the casing 2 to expose and hold the coin.

Further, the coin teller machine 1 has an operating device 21 and a display device 22 provided on the front side of the upper surface of the casing 2. The operating device 21 has a button that accepts an operation of an operator. The display device 22 reports the status and error of the coin teller machine 1 by the characters and the like.

FIG. 2 is a cross-sectional plan view schematically illustrating the structure of the coin teller machine 1. Further, the coin teller machine 1 has a conveying device 5, an identification device 6, a reject device 7 and a storage device 8.

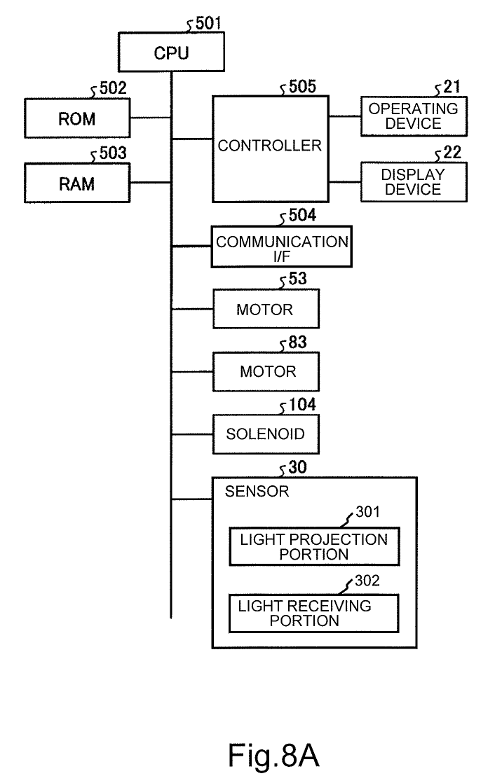

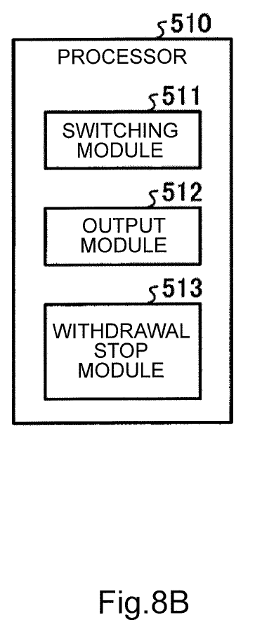

The conveying device 5 conveys the coin, which has been taken into the casing 2 by the insertion slot 3, to the storage device 8. The conveying device 5 has a conveying surface 51 and a conveying belt 52. The conveying surface 51 supports the lower surface of the coin during conveyance. The conveying belt 52 is an endless belt which rotates by receiving a driving force of a motor 53 (see FIG. 8A), and comes into contact with the upper surface of the coin on the conveying surface 51 to move the coin to slid on the conveying surface 51.

The identification device 6 identifies whether the coin being conveyed by the conveying device 5 is a normal coin. The reject device 7 removes the coin identified as an abnormal coin by the identification device 6 from the top of the conveying surface 51. The coins removed by the reject device 7 are discharged to a return tray 9 of the front surface of the casing 2 through the passage provided below the conveying surface 51.

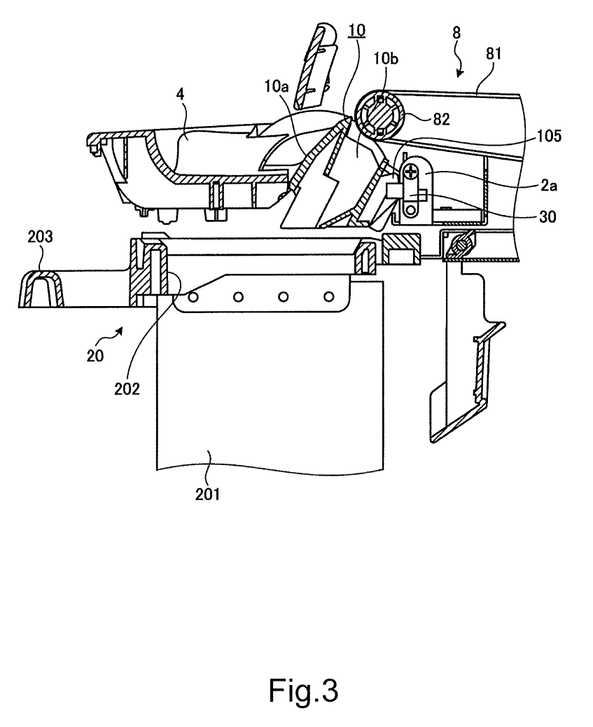

The storage device 8 is provided in the casing 2, stores coins taken in from outside the casing 2, and discharges the stored coins at a predetermined timing. Specifically, for example, the storage device 8 is a container having a lower surface is made up of the endless belt 81. The endless belt 81 is supported to bridge between a plurality of pulleys 82 (one pulley 82 thereof is illustrated in FIG. 3). The endless belt 81 rotates when at least one of the pulleys 82 receives the driving force of the motor 83 (see FIG. 8A). Further, the predetermined timing includes timing when the amount of storage of the coins in the storage device 8 reaches a predetermined amount. Further, the predetermined timing, for example, includes the timing for withdrawing the coins as changes on the basis of the information received by the POS terminal.

The storage device 8 stacks and stores the coins, which are identified as normal coins by the identification device 6, on the endless belt 81. Further, the storage device 8 moves the coins to the front side of the casing 2 by rotating the endless belt 81 and discharges the coins. The storage device 8 performs the discharge at the time of the change payout or coin recovery.

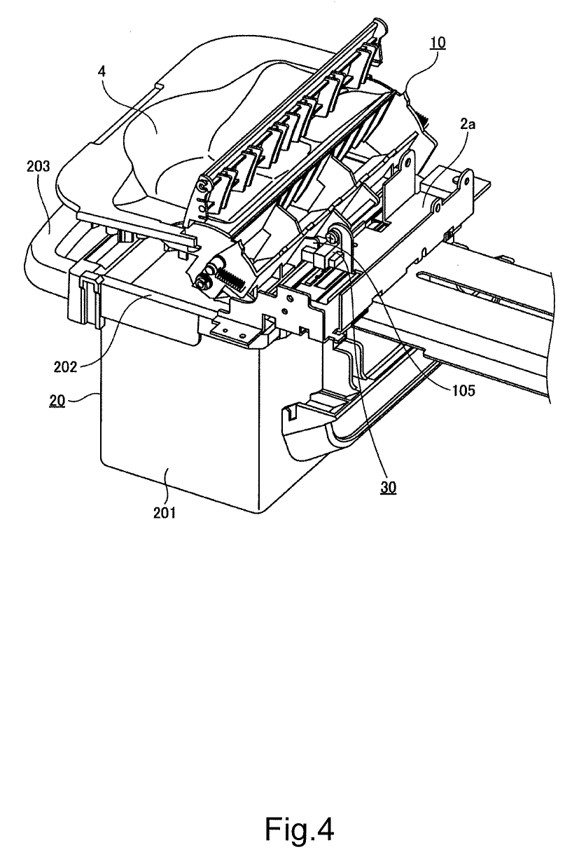

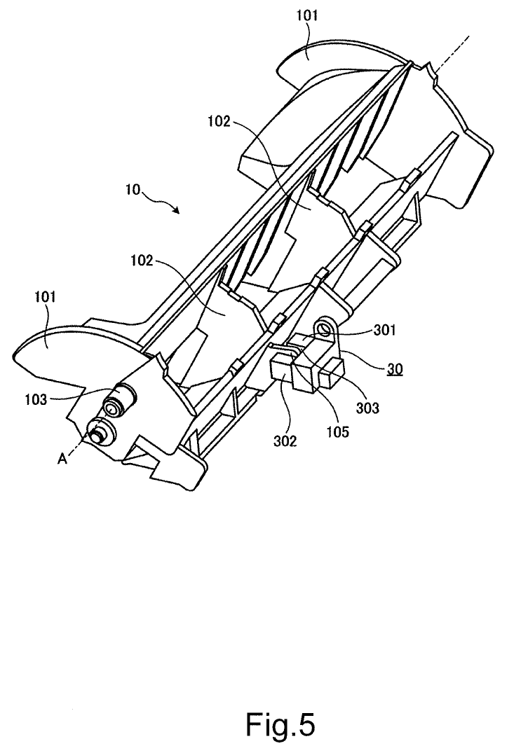

FIG. 3 is a vertical right side view illustrating a structure around the change tray 4. The coin teller machine 1 further has a guide member 10 and a recovery container 20. FIG. 4 is a perspective view illustrating the guide member 10 of the same state as FIG. 3 viewed from the right rear in the drawing. FIG. 5 is a perspective view illustrating an external shape of the guide member 10.

The guide member 10 guides the coins discharged from the storage device 8 to one of the change tray 4 and the recovery container 20. The guide member 10 transfers to one of a first state of guiding the coins discharged by the storage device to the change tray 4, and a second state of guiding the discharged coins to the recovery container 20. That is, switching of the guidance destination of the coins is achieved by transition of the guide member 10 to one of the aforementioned states and the alteration of the direction of the guide member 10.

As illustrated in FIG. 5, the guide member 10 has a cylindrical shape penetrating obliquely in the vertical direction, and has a substantially rectangular parallelepiped shape. The guide member 10 is provided so that its longitudinal direction matches the lateral direction of the coin teller machine 1. Further, the guide member 10 has a blade unit 101 that protrudes forward from the left and right end surfaces. Further, the guide member 10 is reinforced with plate-shaped ribs 102 that partition the cylindrical interior.

Further, the guide member 10 has a protrusion 103 serving as a pivot axis A (indicated by a two-dot chain line in FIG. 5) on the left and right end surfaces. The protrusion 103 is rotatably supported by an immovable portion (not illustrated) of the casing 2. Thus, the guide member 10 freely rotates around the pivot axis A. The direction of the guide member 10 changes with the rotation. The guide member 10 rotates by receiving the driving force of a solenoid 104 (see FIG. 8A).

The guide member 10 transfers from one to the other of the first state and the second state by rotating about the pivot axis A. As mentioned above, the first state is a state of guiding the coins discharged by the storage device 8 to the change tray 4. That is, the first state is a state of the guide member 10 for paying out the change. Hereinafter, the first state will be referred to as a payout state. FIGS. 3 and 4 illustrate the guide member 10 of the payout state. As illustrated in FIGS. 3 and 4, the guide member 10 of the payout state guides the coins discharged from the storage device 8 to the change tray 4 as changes. At this time, the coins slip down over an upward surface 10a (see FIG. 3) of the outer peripheral surface of the guide member 10.

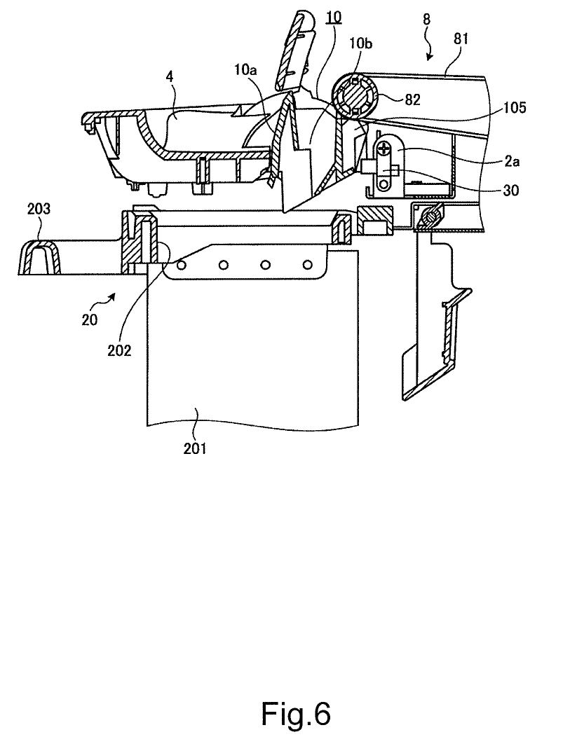

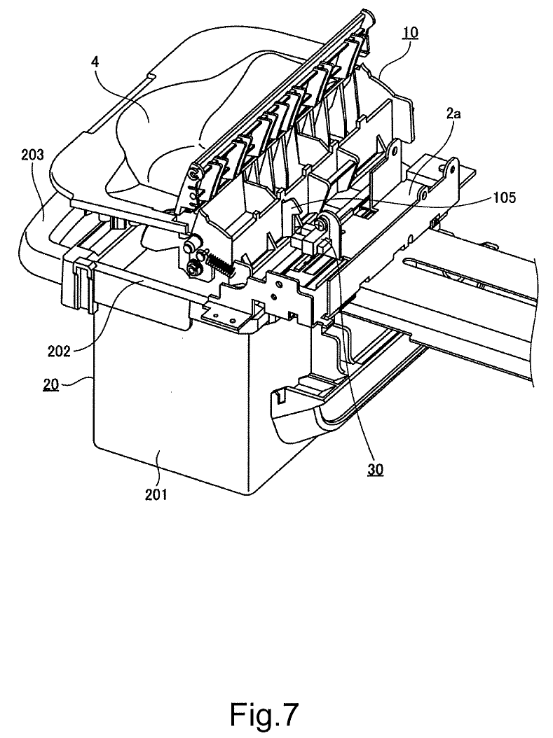

As described above, the second state is a state of guiding the coins discharged by the storage device 8 to the recovery container 20. That is, the second state is a state of the guide member 10 for coin recovery. Hereinafter, the second state will be referred to as a recovery state. FIG. 6 is a vertical right side view illustrating a structure around the guide member 10 and the change tray 4 of the recovery state. FIG. 7 is a perspective view of the guide member 10 in the same recovery state as FIG. 6 viewed from the right rear.

As illustrated in FIGS. 6 and 7, the guide member 10 of the recovery state guides the coins discharged from the storage device 8 to the recovery container 20. At this time, the coin passes through a cylindrical inner side 10b of the guide member 10 (see FIG. 3).

The recovery container 20 recovers the coins stored by the storage device 8. The recovery container 20 is a container that is freely detachably mounted below the change tray 4. The recovery container 20 has a bag 201 and a frame 202. The bag 201 holds the recovered coins. The frame 202 supports the bag 201 in an open state. The frame 202 has a grip portion 203 that is used as a handle by an operator who attaches and detaches the recovery container 20.

Here, as illustrated in FIG. 5, the coin teller machine 1 has a sensor 30 as an example of a detection device. The sensor 30 detects the above-mentioned state of the guide member 10. The sensor 30 is fixed to a bracket 2a (for example, see FIG. 6) immovably provided at a position in the casing 2.

The sensor 30, for example, is an optical sensor that has a light projection portion 301 for emitting light, and a light receiving portion 302 for receiving light emitted from the light projection portion 301. Further, the sensor 30 has a slit 303 between the light projection portion 301 and the light receiving portion 302. The output of the sensor 30 changes, depending on whether the light emitted from the light projection portion 301 is incident on the light receiving portion 302, that is, whether light is not blocked (transmitted) or blocked (shielded) by the slit 303.

The guide member 10 has a thin plate-shaped detection target portion 105 which is provided to protrude to the rear side. The detection target portion 105 moves with switching of the guidance destination of the coin provided by the guide member 10.

The sensor 30 is fixed to the bracket 2a such that the detection target portion 105 of the guide member 10 of the payout state is located at a position within the slit 303 (for example, see FIG. 5). The detection target portion 105 moves to enter and exit the slit 303, with the rotation of the guide member 10. The detection target portion 105 is located at the position outside the slit 303, when the guide member 10 is in the recovery state (for example, see FIG. 7).

FIG. 8A is a block diagram schematically illustrating the electrical connection of the electronic components included in the coin teller machine 1. FIG. 8B is a block diagram illustrating a functional structure of the coin teller machine 1. First, as illustrated in FIG. 8A, the coin teller machine 1 has a central processing unit (CPU) 501, a read only memory (ROM) 502, a random access memory (RAM) 503, a communication I/F (interface) 504, and a controller 505.

The communication I/F 504 communicates with a host device to mediate the transfer of data between the coin teller machine 1 and a host device (not illustrated) such as a POS terminal and a store controller.

The controller 505 transmits a control signal from the CPU 501 to the operating device 21 and the display device 22, and transmits an input signal from the operating device 21 and the display device 22 to the CPU 501. That is, the controller 505 mediates transmission and reception of signals among the operating device 21, the display device 22 and the CPU 501.

The ROM 502 stores various programs executed by the CPU 501. The RAM 503 functions as a work area that stores variable data in a freely rewritable manner.

The CPU 501 functions as various modules by developing the program stored in the ROM 502 to the RAM 503 to execute various arithmetic processes, and totally controls each unit of the coin teller machine 1.

For example, the CPU 501 functions as a processor 510 illustrated in FIG. 8B, by expanding programs stored in the ROM 502 to the RAM 503 and executing the various arithmetic operations. The processor 510 includes a switching module 511, an output module 512 and a withdrawal stop module 513. The processor 510 totally controls each unit of the coin teller machine 1, by functioning as the respective modules 511 to 513.

The switching module 511 controls the switching of the guidance destination of the coins provided by the guide member 10. More specifically, the switching module 511 transmits the control signal to the solenoid 104 that changes the direction of the guide member 10. The solenoid 104 operates by receiving the control signal to rotate the guide member 10.

The switching module 511 of the present embodiment transmits the control signal to the solenoid 104 as described above, when switching the guide member 10 from the payout state to the recovery state. The timing of the transmission, for example, is timing when the storage amount of the storage device 8 exceeds a predetermined threshold value or reaches a predetermined threshold value. The threshold value, for example, may be the number of stored coins or may be a stacked height of the coins. It is possible to determine whether the stacked height of the latter exceeds the threshold value, for example, by providing a transmission type or reflection type optical sensor at a predetermined height inside the storage device 8.

The output module 512 determines the guidance destination of the coin provided by the guide member 10 from the detection result of the sensor 30, and outputs the determination result to a predetermined output destination. The output destination, for example, is the display device 22. The output destination may be a host device, such as a POS terminal or a store controller.

The output module 512 of the present embodiment determines the guidance destination of the coins provided by the guide member 10 as the change tray 4, when the output of the sensor 30 corresponds to “light shielding”.

Further, the output module 512 of the present embodiment can determine that the guidance destination of the coins provided by the guide member 10 is not the change tray 4, when the output of the sensor 30 corresponds to “transparent”. Accordingly, the output module 512 determines the guidance destination as the recovery container 20. In this case, even if the guidance destination of the coin is slightly shifted from the recovery container 20 due to some troubles, it is possible to check that the guidance destination is at least not the change tray 4. That is, even when the storage device 8 discharges the coins in this state, there is no trouble of discharge of the coin to the outside of the casing 2.

The withdrawal stop module 513 stops the discharge of coins from the storage device 8, by stopping the driving of the motor 83, when both of two conditions are satisfied. As one of the conditions, the switching module 511 controls the solenoid 104 such that the guidance destination of the coins provided by the guide member 10 becomes the recovery container 20. As the other condition, the output module 512 determines the guidance destination of the coins provided by the guide member 10 as the change tray 4, based on the detection result of the sensor 30.

Even though the switching module 511 issues an instruction for directing the guidance destination of the coins toward the recovery container 20 to the solenoid 104, when the guide member 10 remains in the payout state, both of the aforementioned two conditions are satisfied. As the cause thereof, for example, some troubles that impede switching to the recovery state, such as a defective operation of the guide member 10 or the solenoid 104 are considered.

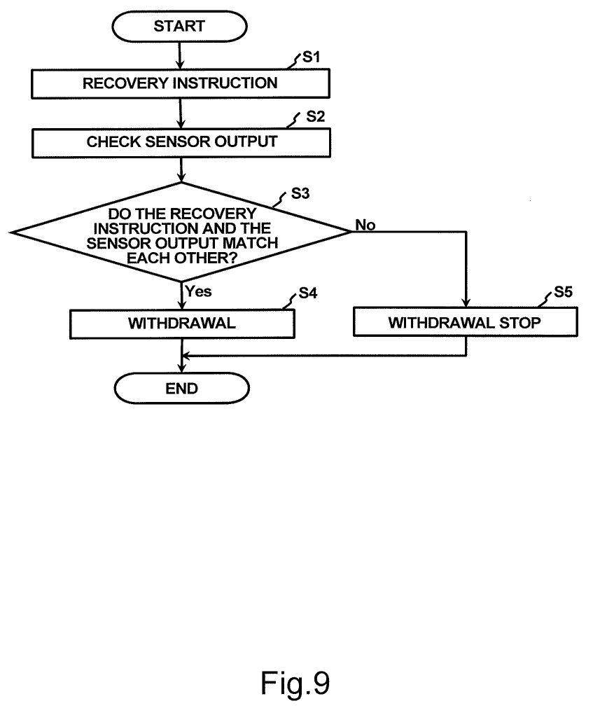

Next, a relation between the operation of the guide member 10 in the coin teller machine 1 and the coin discharge from the storage device 8 will be described with reference to FIG. 9. FIG. 9 is a flowchart schematically illustrating the control performed by the processor 510 for the coin recovery.

First, as illustrated in FIG. 9, in step S1, for the coin recovery, the processor 510 transmits the control signal to the solenoid 104 as the switching module 511. That is, the processor 510 rotates the guide member 10 to perform an instruction for setting the guide member 10 in the recovery state to the solenoid 104.

Next, in step S2, the processor 510 checks the output of the sensor 30 as the output module 512. Further, in step S2, the processor 510 determines the switching state of the guide member 10 based on the output of the sensor 30 as the output module 512, and outputs the determination result to a predetermined output destination, for example, the display device 22.

Subsequently, in step S3, the processor 510 determines whether an instruction to the solenoid 104 and the output of the sensor 30 in the step S1 match each other. That is, the processor 510 determines whether the detection result provided by the sensor 30 indicates the recovery state of the guide member 10.

When the instruction to the solenoid 104 and the output of the sensor 30 match each other (Yes in step S3), the processing of the processor 510 proceeds to step S4. In step S4, the processor 510 performs the withdrawal from the storage device 8 to the recovery container 20 (discharge of the coin) by driving the motor 83. Further, when the instruction to the solenoid 104 and the output of the sensor 30 do not match each other (No in step S3), the processing of the processor 510 proceeds to step S5. In step S5, the processor 510 stops the withdrawal (discharge of coins) from the storage device 8, by stopping the driving of the motor 83 as the withdrawal stop module 513.

In this way, according to this embodiment, at the time of coin recovery, it is possible to avoid the trouble of discharge of a large amount of unintentional coins to the outside of the casing 2.

Further, according to this embodiment, since it is possible to output a detection result to the host device such as a POS terminal or a store controller, it is possible to perform a report or knowledge when the trouble occurs, which can lead to early settlement of the trouble.

In the present embodiment, while the sensor 30 as an optical sensor has been described as an example of a detection device, the detection device may not be the optical sensor. For example, the detection device may be a micro switch, and may have a structure which presses the switch of the micro switch to an operating element provided on the guide member 10.

The shape of the guide member 10 of the present embodiment is an example, and the shape of the guide member 10 is not limited to the embodiment. Further, in the present embodiment, although the switching of the guidance destination of the coin is achieved by rotating the guide member 10 to change the direction of the guide member 10, switching of the guidance destination of the coin is not limited to this method.

(Modification)

In the above-described embodiment, although the coin teller machine 1 for use with a POS terminal has been described, the embodiment is not limited thereto. For example, in an apparatus of a single configuration having the functions of the POS terminal, the bill teller machine and the coin teller machine, the above embodiments may be applied to the coin teller machine of this apparatus. As the apparatus of a single configuration having the functions of the POS terminal, the bill teller machine and the coin teller machine, for example, a self-checkout apparatus (hereinafter, simply referred to as self-POS) installed in a store such as a supermarket and the like is adopted.

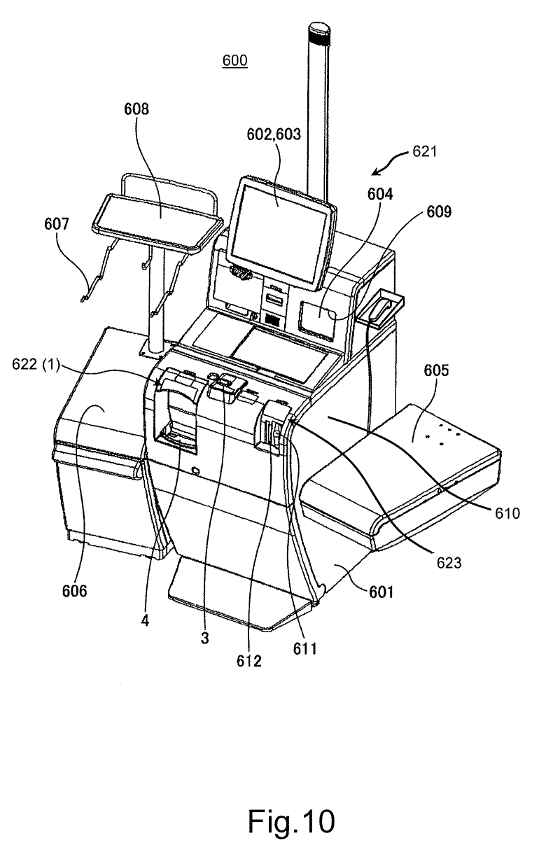

The self-POS will now be described with reference to FIG. 10. FIG. 10 is a perspective view illustrating an external shape of a self-POS 600. Hereinafter, the same configurations as the portions described in the above embodiment are denoted by the same reference numerals, and the repeated description will not be provided.

As illustrated in FIG. 10, the self-POS 600 has a product information processing unit 621, and a change machine 610. The product information processing unit 621 is a so-called POS terminal. Hereinafter, the product information processing unit 621 will be referred to as a POS terminal 621. The POS terminal 621 receives an input of information on the price of products. The POS terminal 621 performs the settlement process, based on the information on the price of the accepted products. The POS terminal 621 has a touch panel 602, a display device 603 and a product reading device 604. The change machine 610 has a coin teller machine 622 and a bill teller machine 623. The coin teller machine 622 deposits and withdraws the coin on the basis of the information on the price of the products that have been accepted by the POS terminal 621. The bill teller machine 623 deposits and withdraws the bill on the basis of the information on the price of the products that have been accepted by the POS terminal 621. Further, the POS terminal 621 has a main body 601, product placing tables 605 and 606, a hook 607, a temporary table 608 and the like.

The touch panel 602 is provided to overlap the surface of the display device 603. As the display device 603, for example, a liquid crystal display is used. The display device 603 displays a guide screen and various input screens for reporting an operating method of the self-POS 600 to a customer. Further, the display device 603 displays a registration screen for displaying the product information that is read by the product reading device 604. Further, the display device 603 displays the total amount of products, the amount of deposit, the amount of change or the like, and displays a settlement screen or the like for selectively displaying the payment method.

The product reading device 604 is a device that reads the product image to recognize (detect) the type of products and the like. The product reading device 604 has a reading window 609. When a code symbol attached to the product is held over the reading window 609 by the customer, the product reading device 604 reads a product image.

The product placing table 605 is a table that the customer places a non-settled product contained in the basket, and is provided on the right side of the main body 601. The product placing table 606 is a table that the customer places a settled product, and is provided on the left side of the main body 601. A bag hook 607 and a temporary table 608 are provided on the product placing table 606. The bag hook 607 is an element that the customer hooks a bag for containing the settled products. The temporary table 608 is a table for temporarily placing the settled products before the customer contains the products in the bag. Each of the product placing tables 605 and 606 has a measurer (not illustrated), and has a function of checking that the weight of the product is the same before and after the settlement.

The change machine 610 performs the reception of the bills and coins for settlement and the payment of the bills and coins as changes, by including the coin teller machine 622 and the bill teller machine 623. The bill teller machine 623 is incorporated in the main body 601 of the self-POS 600. The bill teller machine 623 has a bill insertion slot 611 and a bill payment slot 612 provided on the front surface of the main body 601. The bill teller machine 623 stores the bills taken from the bill insertion slot 611 therein. Further, the bill teller machine 623 discharges the bills accumulated therein from the bill payment slot 612, when it is necessary to pay out the bills as changes. The coin teller machine 622 is the same machine as the aforementioned coin teller machine 1. The coin teller machine 622 is incorporated in the main body 601 of the self-POS 600. The insertion slot 3 and the change tray 4 of the coin teller machine 622 are provided on the front surface of the main body 601. The coin teller machine 622 accumulates the coins taken from the insertion slot 3 in the internal storage device 8, like the aforementioned coin teller machine 1 (for example, see FIG. 2). Further, the coin teller machine 622 discharges coins accumulated in the storage device 8 to the change tray 4, when it is necessary to pay out the coins as changes.

The self-POS 600 functions as the aforementioned coin teller machine 1 by the above configuration.

The program executed in the coin teller machine 1 of the present embodiment is provided by being previously incorporated in a ROM or the like.

The program executed in the coin teller machine 1 of the present embodiment may be provided by being recorded in a computer-readable recording medium such as a CD-ROM, a flexible disk (FD), a CD-R and a digital versatile disk (DVD), by an installable format or an executable format file.

Furthermore, the program executed in the coin teller machine 1 of the present embodiment may be provided by being stored on a computer connected to a network such as Internet, and by being downloaded via the network. Further, the program executed in the coin teller machine 1 of the present embodiment may be provided or distributed via a network such as Internet.

The program executed in the coin teller machine 1 of the present embodiment includes the above-mentioned switching module, the output module and the withdrawal stop module. A CPU (processor) loads the respective modules onto the main storage device, by reading and executing the program from the storage medium. Accordingly, the switching module, the output module, and the withdrawal stop module are generated on the main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coin teller machine comprising:
a casing;
a storage device provided in the casing, configured to store coins taken in from outside the casing and configured to discharge the stored coins at a predetermined timing;
a coin acceptor configured to receive the coins discharged by the storage device by exposing the coins to the outside of the casing;
a recovery container configured to recover the coins stored by the storage device;
a guide member configured to transfer to one of a first state of guiding the coins discharged by the storage device to the coin acceptor, and a second state of guiding the coins discharged by the storage device to the recovery container;
a detection device configured to detect the state of the guide member; and
a processor configured to output a guidance destination of the coin provided by the guide member determined based on the detection result of the detection device to a predetermined output destination.

2. The coin teller machine according to claim 1, wherein the processor controls the transition to one of the first state and the second state of the guide member to guide the coins discharged by the storage device to one of the coin acceptor and the recovery container.

3. The coin teller machine according to claim 2, wherein the processor stops the discharge of the coins provided by the storage device, when controlling the transition of the guide member such that the guide member transfers to the second state, and when the guide member transfers to the first state on the basis of the detection result of the detection device.

4. The coin teller machine according to claim 1, wherein the guide member has a detection target portion which moves with the transition of the state, and
the detection device detects the position of the detection target portion.

5. The coin teller machine according to claim 4, wherein the detection device comprises an optical sensor in which an output changes depending on the position of the detection target portion.

6. The coin teller machine according to claim 5, wherein the detection device comprises a transmission type optical sensor in which a light projection portion and a light receiving portion face each other via a slit through which the detection target portion enters and exits, and the detection device is provided inside the casing so that the detection target portion is located at a position within the slit when the guide member transfers to the first state.

7. A self-checkout apparatus comprising:
a product information processing unit configured to receive an input of information on price of a product;
a coin teller machine configured to deposit and withdraw coins based on information received by the product information processing unit; and
a bill teller machine configured to deposit and withdraw bills based on information received by the product information processing unit,
wherein the coin teller machine comprises:
a casing;
a storage device provided in the casing, configured to store coins taken in from outside the casing, and configured to discharge the stored coins at a predetermined timing;
a coin acceptor configured to receive the coins discharged by the storage device by exposing the coins to the outside of the casing;
a recovery container configured to recover the coins stored by the storage device;
a guide member configured to transfer to one of a first state of guiding the coins discharged by the storage device to the coin acceptor, and a second state of guiding the coins discharged by the storage device to the recovery container;
a detection device configured to detect the state of the guide member; and
a processor configured to output a guidance destination of the coin provided by the guide member determined based on the detection result of the detection device to a predetermined output destination.

8. The self-checkout apparatus according to claim 7, wherein the processor controls the transition to one of the first state and the second state of the guide member to guide the coins discharged by the storage device to one of the coin acceptor and the recovery container.

9. The self-checkout apparatus according to claim 8, wherein the processor stops the discharge of the coins provided by the storage device, when controlling the transition of the guide member such that the guide member transfers to the second state, and when the guide member transfers to the first state on the basis of the detection result of the detection device.

10. The self-checkout apparatus according to claim 7, wherein the guide member has a detection target portion which moves with the transition of the state, and
the detection device detects the position of the detection target portion.

11. The self-checkout apparatus according to claim 10, wherein the detection device comprises an optical sensor in which an output changes depending on the position of the detection target portion.

12. The self-checkout apparatus according to claim 11, wherein the detection device comprises a transmission type optical sensor in which a light projection portion and a light receiving portion face each other via a slit through which the detection target portion enters and exits, and the detection device is provided inside the casing so that the detection target portion is located at a position within the slit when the guide member transits to the first state.
